(19) United States
(12) Patent Application Publication
(10) Pub. No.: US 2026/0310905 A1
(43) Pub. Date: Oct. 8, 2026

(54) METHODS AND SYSTEMS FOR PROVIDING NATURAL LANGUAGE RESPONSES TO MULTI-MODAL INPUTS

(71) Applicant: Y.E. Hub Armenia LLC, Yerevan (AM)

(72) Inventors: Elena BONDAR, Moscow (RU); Ekaterina GLAZKOVA, Moscow (RU); Roman ISACHENKO, Moscow (RU); Konstantin LAKHMAN, Moscow (RU); Nikolay MATSUK, Moscow (RU); Igor MEDVEDEV, Moscow (RU); Sergei OVCHARENKO, Moscow (RU); Artem PROKHOROV, Moscow (RU); Alexander SAPATOV, Moscow (RU); Olga KHRUSTALEVA, Moscow (RU); Artem KHURSHUDOV, Moscow (RU); Pavel SHTYKOV, Moscow (RU)

(21) Appl. No.: 19/401,293

(22) Filed: Nov. 25, 2025

(30) Foreign Application Priority Data
Apr. 3, 2025 (RU) 2025108251

(51) Int. Cl. G06F 40/40; G06N 3/0475; G06N 3/08; G06V 10/774; G06V 10/94; G06V 30/19

(52) U.S. Cl. CPC G06F 40/40; G06N 3/0475; G06N 3/08; G06V 10/774; G06V 10/95; G06V 30/19147

(57) ABSTRACT

Methods and servers for generating a Natural Language (NL) response to a multi-modal input are disclosed. The method includes acquiring a multi-modal input comprising a NL request and an image, generating first textual information for the image indicative of one or more visual search results relevant to the image, generating a modified NL request based on the NL request, the first textual information, and the image, generating a second textual information for the image based on the NL request and the image, generating third textual information based on the modified NL request, generating a NL response based on at least the modified NL request, the second textual information and the third textual information and triggering display of the NL response on the user device as a response to the multi-modal input.

### CROSS-REFERENCE

The present application claims priority to Russian Patent Application No. 2025108251, entitled “Methods and Systems for Providing Natural Language Responses to Multi-Modal Inputs”, filed Apr. 3, 2025, the entirety of which is incorporated herein by reference.

### FIELD

The present technology relates to multi-modal input processing, and more specifically, to methods and systems for providing natural language responses to multi-modal inputs.

### BACKGROUND

Conventional web search engines operate using a process that includes web crawling, indexing, and document retrieval. Web crawlers systematically traverse the internet, collecting data from various types of content including text, images, and videos. The gathered content is processed and stored in searchable indexes. When a user submits a query, the search engine retrieves and ranks relevant documents from the index, returning a list of results based on query relevance, often referred to as a Search Engine Results Page (SERP).

Recent advancements have introduced the integration of Large Language Models (LLMs) into information retrieval systems. In such hybrid systems, a dialogue-based LLM interact with a search engine to enhance the user experience through Natural Language (NL) understanding and conversational capabilities. These systems allow users to pose complex or multi-faceted questions using natural, conversational language. The LLM interprets the user's intent and context, queries the search engine for relevant data, and synthesizes the retrieved information into coherent responses. This reduces the user's need to examine multiple sources and enables follow-up interactions for query refinement, if need be.

However, the integration of LLMs and search engines poses many technical challenges. Given the volume and diversity of data retrievable by search engines, generating accurate and contextually appropriate responses remains a complex task. Moreover, maintaining the timeliness and reliability of responses requires the use sophisticated mechanisms to ensure real-time data access and understanding.

An example of this emerging technology is Yandex™ Neuro™ Search service, which exemplifies a real-world implementation of an integrated search engine(s) and LLM(s). The Neuro Search service combines the Yandex™ search engine with YandexGPT3™ model to identify relevant sources and generate concise, cited responses. YandexGPT3™ model is a transformed-based generative pre-trained transformer model operated by Yandex™. The Neuro Search service supports follow-up questions, contextual conversation, and input via NL and/or images. The Neuro Search service retrieves and summarizes information from current, real-time search results, enabling up-to-date and trustworthy answers.

However, current solutions need improvements for increasing operational performance and response quality of dialogue-based LLM systems integrated with web search engines when facing multi-modal requests comprising text and images, for example.

International application WO 2025/034428 discloses a method of generating multi-modal response(s) through utilization of LLMs.

### SUMMARY

It is an object of the present technology to ameliorate at least some of the inconveniences present in the prior art. Embodiments of the present technology may provide and/or broaden the scope of approaches to and/or methods of achieving the aims and objects of the present technology.

Developers of the present technology have realized that some existing solutions integrate search engines with Large Language Models (LLMs), and may provide a generated response based on up-to-date web content, and citing relevant resources. Some existing solutions also support multi-modal input, allowing users to submit request via images in addition to Natural Language (NL) text.

Developers have identified at least some limitations that impact response accuracy of such solutions, especially in multi-modal scenarios. In current systems, multi-modal requests are processed using a combination of unimodal components-that is, a visual search engine extracts metadata (such as tags and/or recognized text) from the image, which is then used in conjunction with the original NL request to generate a final textual search request via a request modifying LLM. This modified request is then submitted to a text search engine, and textual search engine results are used to generate a final response by a response LLM.

Developers have realized that the request modifying LLM operates without direct access to the original image-that is, the request modifying LLM of traditional systems only receives textual information from the visual search engine. As a result, the request modifying LLM may not “understand” the user's intent in the context of the visual content of the image itself, leading to potential misinterpretations and/or drop in performance. For example, an image showing both a dog and an apple accompanied by the question “How many calories?” may result in an incorrect modification such as “How many calories are in a pug?” due to ambiguity in the image tags (textual information from the visual search engine).

Developers have realized that traditional request modifying LLMs rely on text-based “intermediate” representations rather than on holistic image understanding—i.e., the traditional request modifying LLMs do not consider the visual content of the image itself, but rather text-based intermediate representations extracted based on the visual content. For example, if a relevant tag is missing or is ambiguous, the system may formulate an inaccurate modified request, and therefore resulting in drop in performance. Developers have realized that traditional request modifying LLMs are suited for unimodal data processing but are nevertheless used for processing multi-modal requests. As a result, traditional request modifying LLMs are ill-suited for multi-modal capabilities for context-aware systems that may require joint analysis of image and textual data during the request modification process.

At least one drawback of conventional systems is their reliance solely on pre-trained models. In at least some embodiments of the present technology, there is provided a system that is configured to fine-tune one or more LLMs and one or more VLMs for use during multi-modal input processing, instead of solely using “prompt engineering” to direct the behavior of the one or more LLMs and the one or more VLMs. In these embodiments, the system may comprise one or more fine-tuned LLMs and one or more fine-tuned VLMs to aid in increasing performance of the multi-modal input processing system.

At least one drawback of conventional systems is generation of descriptions of different image regions using a detector and iteratively refining the so-generated descriptions by re-prompting data from neighbouring image regions. In some embodiments of the present technology, there is provided a system that comprises at least one VLM configured to generate a textual description, or “caption”, for the entire image. It can be said the at least one VLM may be configured to process all visual content of the image for generation the image caption. Developers of the present technology have realized that such an “image-holistic” approach may aid in increasing accuracy of the multi-modal input processing system and/or may aid in generating contextually grounded modified NL requests.

At least one drawback of conventional systems is the use of text-only searching processes, where only text descriptions derived from the image regions are used to generate requests for text-only internet search. It should be noted that systems using text-only searching processes are likely to underperform in solving tasks that rely on a visual context of the image such as, but not limited to: art identification, celebrity recognition, and event discovery. In at least some embodiments of the present technology, there is provided a system that leverages both text searching processes and visual searching processes. In these embodiments, the system comprises a text search engine for generating text-based search results, and a visual search engine for generating visual search results. Both the text-based search results and the visual search results may be used for generating a response to the multi-modal input. Developers of the present technology have realized that using both an image-based search (e.g., on full image and/or image crops) and a text-based search may aid in increasing the precision of the multi-modal input processing system.

Developers have realized that text-only searching processes rely solely on textual data and thereby may lack the specificity and nuance needed to accurately capture what is “visually unique” about an image in a multi-modal input.

By way of illustration, consider the introduction of a novel mobile phone model on a given date. The new mobile phone model may possess distinct visual characteristics not present in prior models of the mobile phone, although being similar. A multi-modal input processing system incorporating visual search capabilities may, upon updating its database and/or indexes, adapt more quickly (e.g., database and/or index updates may occur within hours or days) to such scenarios after the availability of the new mobile phone model images. Such a system may therefore allow for retrieval of an accurate name and/or specifications of the new mobile phone model, based on associated metadata and/or links to relevant sources describing a “fresh” image of the new mobile phone model.

Conversely, a text-only LLM-based systems, not reliant of VLMs and/or visual search engines, may produce generalized text information (e.g., “blue phone with four cameras”) based on the input image. Such information, lacks specificity and may yield imprecise and/or irrelevant search results in a form of a previous mobile phone model and/or a mobile phone model from a different manufacturer. Furthermore, accurate identification of the new mobile model within the text-only LLM-based systems may require retraining one or more LLMs based on an updated dataset, which is computationally intensive and/or may be performed within a comparatively longer period of time (several weeks to months) than updates of databases and/or indexes employed by visual search engines.

At least one drawback of conventional systems is the use “iteration heavy” processes where potential requests and document retrieval operations are iteratively repeated, with iteration results being iteratively evaluated and iteratively summarized during each iteration. Developers of the present technology have realized that iteration heavy processes may increase the need for a large amount of computational resources and/or result in reduced responsiveness of the multi-modal request processing system. In at least some embodiments of the present technology, there is provided a system in a “single-pass” configuration, during which one image search operation and one text search operation is performed to generate the result to the multi-modal input, thereby having a comparatively lower computational cost than iteration heavy systems.

In at least some embodiments of the present technology, there is provided a system with a first Visual Language Model (VLM), sometimes referred to as a “rephraser”, for generating a modified NL request, instead of a conventional LLM rephraser. In one embodiment, the rephraser is configured to acquire at least the following inputs: the user's original NL request, the input image, and textual information indicative of visual search results. By analyzing the inputs, the VLM rephraser configured to modify the original NL request so that a modified NL request is a better representation of the image-text pair. In one non-limiting example, if the original NL request was “When did it appear?” but the input image shows the Colosseum, the VLM rephraser may modify the NL request to “When did the Colosseum appear?”.

In at least some embodiments of the present technology, there is provided a system with a second VLM, sometimes referred to as a “captioner”, for generating textual information indicative of a description or “caption” of the image. The captioner receives at least one of the original NL request and the modified NL request, as well as the image, and outputs a NL description of the visual content. This NL description is not simply appended to the final response but is treated as an additional context source that a LLM “generator” can use for generating the NL response. In one non-limiting example, instead of generating a NL response “72 A.D.” the LLM generator may employ the captioner output for generating the NL response “The image shows the Colosseum amphitheater under the rays of the setting sun. It was first built in 72 A.D.”.

In at least some embodiments, the LLM generator may be frequently re-trained/updated while re-training/updating the one or more VLMs (rephraser and/or captioner) comparatively less frequently for reducing the computational cost of updating the system. In other words, since the VLM components of the system are modular, the system can be updated with comparatively less computational cost, while still preserving the strong language modeling capabilities of the service.

In at least some embodiments, developers have devised a training framework which employ a “rewriter” model to enable a (text-only) LLM to operate in multimodal scenarios that involve both textual and visual inputs. For example, the LLM can be trained using a supervised fine-tuning (SFT) phase followed by Reinforcement Learning (RL) phase. During a third stage, the rewriter model (a lightweight neural network) is configured to generate training data for further training the LLM.

Developers have measured at least one performance metric for the multi-modal input system as implemented in some embodiments of the present technology and for at least one conventional multi-modal input system employing LLMs. For example, some measurements have been performed in a Side-by-Side (SbS) study, comparing a conventional LLM-based system with a VLM-based system in accordance with at least some embodiments of the present technology. The evaluation set comprises different sets of images and requests which align with a variety of search scenarios. Without wishing to be bound to any specific theory, the SbS measurement demonstrates that overall quality of final response with a convention LLM-based system is 36%, and with a VLM-based system is 64%.

In a first broad aspect of the present technology, there is provided a method of generating a Natural Language (NL) response to a multi-modal input, the method executable by a server, the server communicatively coupled to a user device, the method comprising: acquiring, from the user device, a multi-modal input comprising a NL request and an image; generating, using a visual search engine, first textual information for the image indicative of one or more visual search results relevant to the image; generating, using a first Visual Language Model (VLM), a modified NL request based on the NL request, the first textual information, and the image, the modified NL request being a modified version of the NL request; generating, using a second VLM different from the first VLM, a second textual information for the image based on the NL request and the image, the second textual information being indicative of a NL description of the image; generating, using a text-based search engine, third textual information based on the modified NL request, the third textual information being indicative of one or more text-based search results relevant to the modified NL request; generating, using a Large Language Model (LLM), a NL response based on at least the modified NL request, the second textual information and the third textual information; and triggering display of the NL response on the user device as a response to the multi-modal input.

In some embodiments of the method, generating the NL response is further based on at least one of the NL request, and the first textual information.

In some embodiments of the method, the first textual information comprises at least one of a textual tag, recognized text in the image, web page content, and image object card.

In some embodiments of the method, the visual search engine is configured to employ a computer vision model to generate at least a portion of the first textual information.

In some embodiments of the method, the visual search engine is configured to employ an Optical Character Recognition (OCR) model to generate at least a portion of the first textual information.

In some embodiments of the method, the generating the third textual information comprises: determining, by the text-based search engine, one or more web resources that are relevant to the modified NL request, the one or more web resources representative the one or more text-based search results; and generating the third textual information based on content from the one or more web resources.

In some embodiments of the method, the method further comprises training the LLM, the training comprising: generating, by a rewriter model, an output representative of a target multi-modal NL response based on a user NL request, a corresponding modified NL request, a description of a corresponding image, and a text-only NL response; generating a synthetic training set comprising the user NL request, the corresponding modified NL request, the description of the corresponding image, and the target multi-modal NL response; and training the LLM using the synthetic training set.

In some embodiments of the method, the first VLM comprises an image encoder, an adapter and another LLM.

In some embodiments of the method, the second VLM comprises an image encoder, an adapter and an other LLM.

In some embodiments of the method, the LLM is a generative pre-trained transformer (GPT) model.

In a second broad aspect of the present technology, there is provided a server for generating a Natural Language (NL) response to a multi-modal input, the server communicatively coupled to a user device, the server configured to: acquire, from the user device, a multi-modal input comprising a NL request and an image; generate, using a visual search engine, first textual information for the image indicative of one or more visual search results relevant to the image; generate, using a first Visual Language Model (VLM), a modified NL request based on the NL request, the first textual information, and the image, the modified NL request being a modified version of the NL request; generate, using a second VLM different from the first VLM, a second textual information for the image based on the NL request and the image, the second textual information being indicative of a NL description of the image; generate, using a text-based search engine, third textual information based on the modified NL request, the third textual information being indicative of one or more text-based search results relevant to the modified NL request; generate, using a Large Language Model (LLM), a NL response based on at least the modified NL request, the second textual information and the third textual information; and trigger display of the NL response on the user device as a response to the multi-modal input.

In some embodiments of the server, to generate the NL response is further based on at least one of the NL request, and the first textual information.

In some embodiments of the server, the first textual information comprises at least one of a textual tag, recognized text in the image, web page content, and image object card.

In some embodiments of the server, the visual search engine is configured to employ a computer vision model to generate at least a portion of the first textual information.

In some embodiments of the server, the visual search engine is configured to employ an Optical Character Recognition (OCR) model to generate at least a portion of the first textual information.

In some embodiments of the server, to generate the third textual information comprises the server configured to: determine, by the text-based search engine, one or more web resources that are relevant to the modified NL request, the one or more web resources representative the one or more text-based search results; and generate the third textual information based on content from the one or more web resources.

In some embodiments of the server, the server is further configured to train the LLM, to train comprises the server configured to: generate, by a rewriter model, an output representative of a target multi-modal NL response based on a user NL request, a corresponding modified NL request, a description of a corresponding image, and a text-only NL response; generate a synthetic training set comprising the user NL request, the corresponding modified NL request, the description of the corresponding image, and the target multi-modal NL response; and train the LLM using the synthetic training set.

In some embodiments of the server, the first VLM comprises an image encoder, an adapter and an other LLM.

In some embodiments of the server, the second VLM comprises an image encoder, an adapter and an other LLM.

In some embodiments of the server, the LLM is a generative pre-trained transformer (GPT) model.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic representation of a computer system, in accordance with at least some non-limiting embodiments of the present technology.

FIG. 2 is a schematic representation of a networked system, in accordance with at least some non-limiting embodiments of the present technology.

FIG. 3 is a schematic representation of a multi-modal input processing system executable by a server of FIG. 2, in accordance with at least some non-limiting embodiments of the present technology.

FIG. 4 is a schematic representation of a multi-modal input processing pipeline executable by the multi-modal input processing system.

FIG. 5 is a schematic representation of an architecture of a Visual Language Model (VLM) used by the multi-modal input processing system, in accordance with at least some non-limiting embodiments of the present technology.

FIG. 6 is a schematic representation of a training pipeline of the VLM of FIG. 5, in accordance with at least some non-limiting embodiments of the present technology.

FIG. 7 is a screenshot of a Visual Search Engine Results Page (VSERP) generated by a visual search engine of the multi-modal input processing system, in accordance with at least some non-limiting embodiments of the present technology.

FIG. 8 is a schematic representation of a machine learning model used to train a Large Language Model (LLM) in the multi-modal input processing pipeline, in accordance with at least some non-limiting embodiments of the present technology.

FIG. 9 is a scheme-block representation of an other method executable by a computer system of FIG. 1, in accordance with at least some non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

In the context of the present specification, a “server” refers to hardware capable of receiving requests (e.g., from client devices) over a network, and carrying out those requests, or causing those requests to be carried out (e.g., via one or more computer programs executed by the server). The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

The functions of the various elements shown in the figures, including any functional block labeled as a “processor” or a “graphics processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

In the context of the present specification, “machine learning” refers to a subset of AI techniques where algorithms enable systems to automatically learn from data and improve their performance over time without being explicitly programmed. Machine learning models learn patterns and relationships within the data and apply these learned insights to make predictions and/or decisions in various tasks such as, but not limiting to: natural language processing, natural language generation, image recognition, and searching.

In the context of the present specification, the term “Natural Language Processing” (NLP) refers to a subfield of artificial intelligence (AI) relating to interaction between computers and human language. NLP technologies enable computer systems to analyze, interpret, and generate human, Natural Language (NL), in a manner that is both semantically meaningful and contextually appropriate.

In the context of the present specification, a “Generative Pre-trained Transformer” (GPT) model refers to a neural network model having a transformer-based architecture a trained on extensive and diverse data. The GPT model is designed to generate human-like text by predicting a next textual token in a sequence based on contextual information acquired via one or more attention mechanisms.

In the context of the present specification, a “generative model” refers to an AI model that is configured to generate or “create” new data (e.g., text tokens) based on patterns learned from vast amounts of training data. Generative models can generate different types of new data. For example, a given generative model may generate textual data. In another example, an other given generative model may generate image data.

In the context of the present specification, a “Large Language Model” (LLM) refers to a type of machine learning model, sometimes based on transformer architectures, that is trained on vast amounts of text data to perform various NL processing tasks. LLMs are capable of understanding, generating, and manipulating human language by modeling statistical relationships between words, phrases, and contextual patterns across large-scale corpora.

In the context of the present specification, a “Visual Language Model” (VLM) refers to a machine learning model that is configured to combine and process visual and linguistic data to perform tasks that require multi-modal understanding. A VLM can be trained on paired image-text datasets and is configured to generate text-based outputs based on visual and/or text inputs, or vice versa, thereby enabling interpretation and reasoning across both visual and textual modalities.

In the context of the present specification, “Supervised Fine-Tuning” (SFT) refers to a machine learning framework in which a pre-trained model (e.g., LLM or VLM) is further trained on a labeled dataset to adapt the pre-trained model to a specific application and/or domain. This SFT process utilizes annotated examples to guide the model's output, enabling it to leverage its prior general training (pre-training) for improved accuracy and/or relevance in task-specific scenarios.

In the context of the present specification, “Reinforcement Learning” (RL) refers to a machine learning framework in which a model (e.g., pre-trained and SFT-trained model) learns to make decisions through iterative interaction with an environment. The model receives evaluative feedback in the form of rewards or penalties based on its actions, which it uses to adjust future behavior with the goal of maximizing a cumulative reward signal over time.

In the context of the present specification, a “search engine” refers to a computational system designed to retrieve, rank, and present relevant digital content such as web pages, documents, and other data objects, for example, from a structured database and/or index. The search engine operates in response to a user-generated request and typically employs algorithms that analyze textual, structural, or semantic features of both the request and the indexed content to determine relevance.

In the context of the present specification, “indexing” refers to the process by which digital content is collected, analyzed, and systematically organized into a searchable format for efficient retrieval by a search engine. This process may include parsing content, extracting features, generating metadata, and/or storing structured representations of data in an index (e. g, inverted index) to enable relevance-based querying and ranking.

In the context of the present specification, a “text-based search engine” refers to a search engine that processes textual requests to identify and return relevant documents or content based primarily on textual analysis. Such systems utilize techniques including keyword matching, semantic analysis, and ranking algorithms to search indexed text data.

In the context of the present specification, a “visual search engine” refers to a search engine that processes visual inputs such as images, or video frames, for example, as requests to retrieve relevant visual content. These systems typically employ computer vision techniques to extract visual features from the input and match them against an indexed database of visual data.

In the context of the present specification, a “computer vision model” refers to machine learning model that is trained to interpret and analyze visual content, such as digital images or video frames. The computer vision model may have different architectures such as a Convolutional Neural Network (CNN) and a transformer-based architecture, and other embedding architectures, for example. The computer vision model is configured to perform tasks such as object detection, image classification, segmentation, OCR, and scene recognition. The computer vision model is configured to extracts and processes visual features to generate structured outputs that represent meaningful interpretations of the input, thereby enabling systems to understand and respond to visual information in an automated manner.

With these fundamentals in place, we will now consider some non-limiting examples to illustrate various implementations of aspects of the present technology.

### Computer System

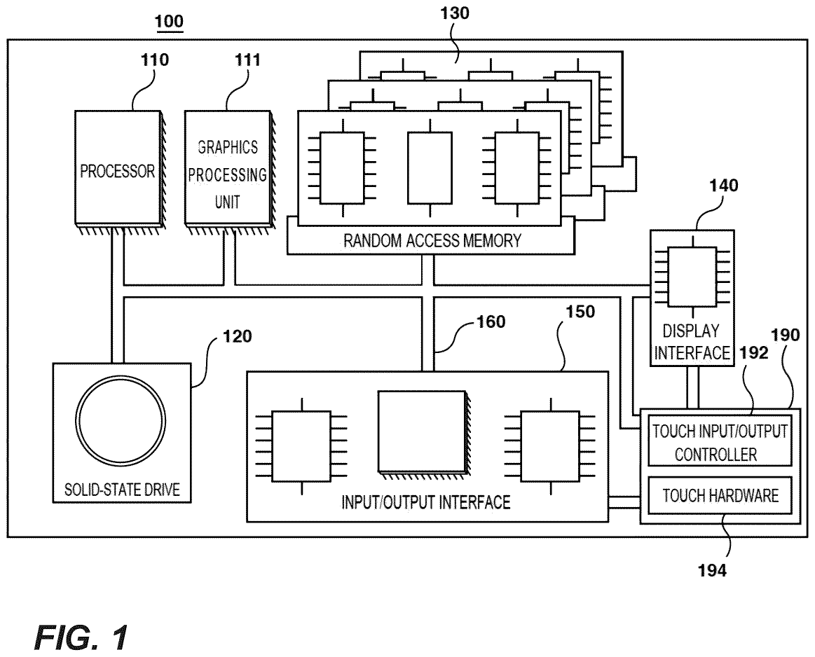

With reference to FIG. 1, there is depicted a computer system 100 suitable for use with some implementations of the present technology. The computer system 100 comprises various hardware components including one or more single or multi-core processors collectively represented by a processor 110, a graphics processing unit (GPU) 111, a solid-state drive 120, a random-access memory 130, a display interface 140, and an input/output interface 150.

According to implementations of the present technology, the solid-state drive 120 stores program instructions suitable for being loaded into the random-access memory 130 and executed by the processor 110 and/or the GPU 111. For example, the program instructions may be part of a library and/or an application.

Communication between the various components of the computer system 100 may be enabled by one or more internal and/or external buses 160 (e.g. a PCI bus, universal serial bus, IEEE 1394 “Firewire” bus, SCSI bus, Serial-ATA bus, etc.), to which the various hardware components are electronically coupled.

The input/output interface 150 may be coupled to a touchscreen 190 and/or to the one or more internal and/or external buses 160. It is noted that some components of the computer system 100 can be omitted in some non-limiting embodiments of the present technology. For example, the keyboard and the mouse (both not separately depicted) can be omitted, especially (but not limited to) where the computer system 100 is implemented as a compact electronic device.

Broadly speaking, the touchscreen 190 may comprise touch hardware 194 and a touch input/output controller 192 allowing communication with the display interface 140 and/or the one or more internal and/or external buses 160. In some embodiments, the touch hardware 194 may comprise pressure-sensitive cells embedded in a layer of a display allowing detection of a physical interaction between a user and the display.

It should be noted that various implementations of the computer system 100 are contemplated. As it will become apparent from the description herein further below, one or more computer system connected over communication network may be implemented similarly to the computer system 100, without departing from the scope of the present technology.

### Networked Environment

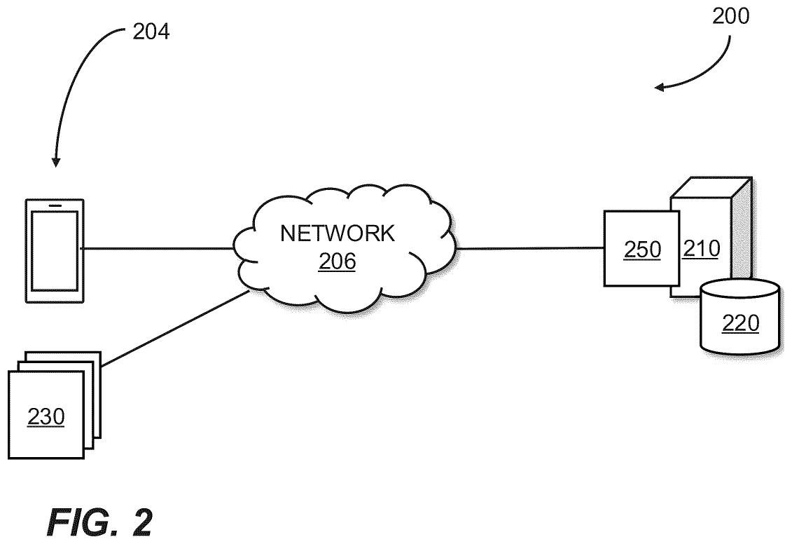

Referring to FIG. 2, there is shown a schematic diagram of a networked environment 200, the networked environment 200 being suitable for implementing non-limiting embodiments of the present technology. It is to be expressly understood that the networked environment 200 as depicted is merely an illustrative implementation of the present technology. Thus, the description thereof that follows is intended to be only a description of illustrative examples of the present technology.

Broadly speaking, the networked environment 200 is configured for providing communication between inter alia a plurality of electronic devices 204, a communication network 206, and a server 210.

As mentioned above, the networked environment 200 comprises an electronic device 204. As such, the electronic device 204, or simply “device” 204 can sometimes be referred to as a “client device”. In the context of the present specification, unless provided expressly otherwise, “electronic device” or “device” is any computer hardware that is capable of running a software appropriate to the relevant task at hand. Thus, some non-limiting examples of the device 204 include personal computers (desktops, laptops, netbooks, etc.), smartphones, tablets and the like. In one embodiment, the device 204 may be implemented similarly to how the computer system 100 is implemented. The device 204 comprises hardware and/or software and/or firmware (or a combination thereof), as is known in the art, to transmit requests to the server 210.

The networked environment 200 comprises the communication network 206. In one non-limiting example, the communication network 206 may be implemented as the Internet. In other non-limiting examples, the communication network 206 may be implemented differently, such as any wide-area communication network, local-area communication network, a private communication network and the like. In fact, how the communication network 206 is implemented is not limiting and will depend on inter alia how other components of the networked environment 200 are implemented.

The purpose of the communication network 206 is to communicatively couple at least some of the components of the networked environment 200 such as the client device 204, the server 210, and the database system 220. For example, this means that the server 210 is accessible via the communication network 206 by the client device 204. The communication network 206 may be used in order to transmit information between the client device 204 and the server 210. The transmitted information may be representative of inter alia multi-modal inputs and NL responses.

The networked environment 200 comprises the server 210 that may be implemented as a conventional computer server. In an example of an embodiment of the present technology, the server 210 may be implemented as a Dell™ PowerEdge™ Server running the Linux™ operating system. Needless to say, the server 210 may be implemented in any other suitable hardware and/or software and/or firmware or a combination thereof. In the depicted non-limiting embodiment of present technology, the server 210 is a single server. In alternative non-limiting embodiments of the present technology, the functionality of the server 210 may be distributed and may be implemented via multiple servers. In one embodiment, the server 210 may be implemented similarly to how the computer system 100 is implemented.

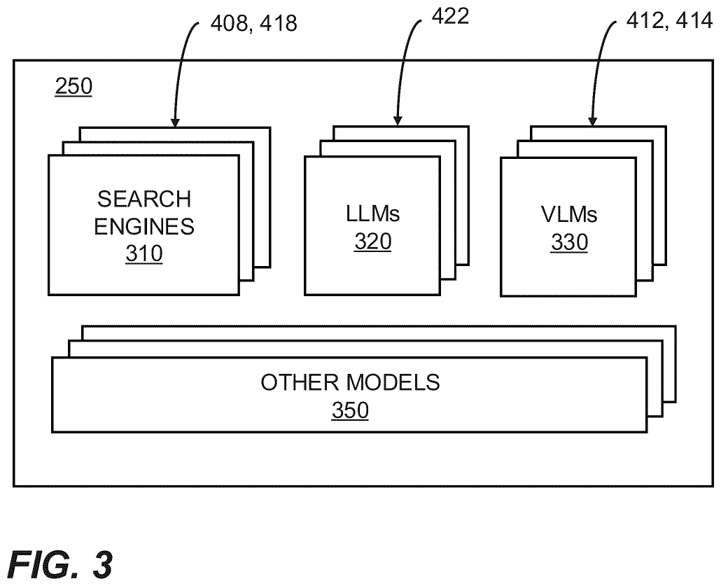

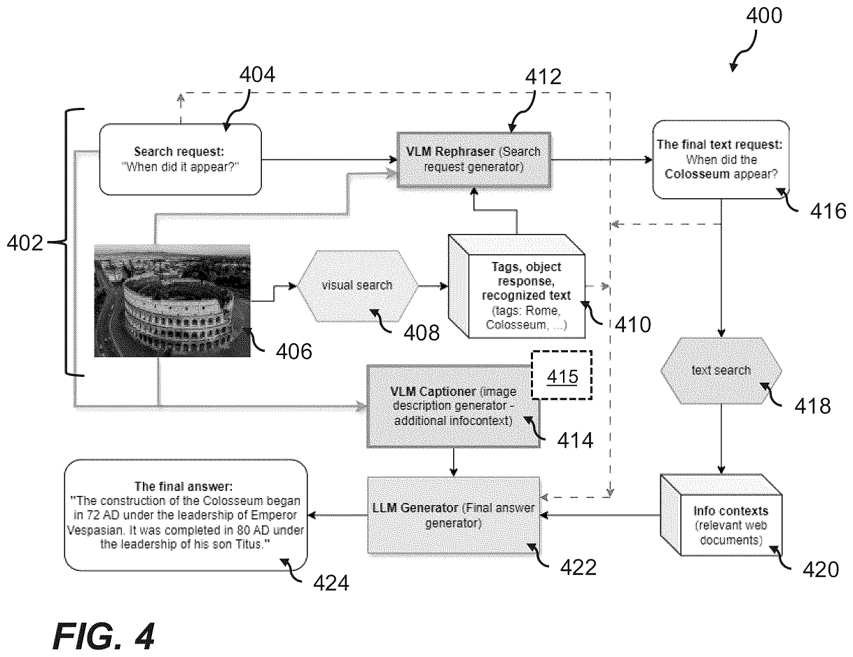

The server 210 is configured to execute a multi-modal input processing system 250. The multi-modal input processing system 250 is configured to acquire from the client device 204 a multi-modal input comprising a NL request, and an image. The multi-modal input processing system 250 is configured to process the multi-modal input and generate a response. The response may be transmitted to the client device 204 for display to a corresponding user. How the multi-modal input processing system 250 is configured for processing the multi-modal input will be described in greater details herein further below with reference to FIGS. 3 and 4.

As mentioned above, the plurality of resource servers 230 can be accessed via the communication network 206. The plurality of resource servers 230 may be implemented as conventional computer servers. In a non-limiting example of an embodiment of the present technology, a given one of the plurality of resource servers 230 may be implemented as a Dell™ PowerEdge™ Server running the Microsoft™ Windows Server™ operating system. The given one of the plurality of resource servers 230 may also be implemented in any other suitable hardware and/or software and/or firmware or a combination thereof.

The plurality of resource servers 230 are configured to host (web) resources that can be accessed by the device 204 and/or by the server 210. Which type of resources the plurality of resource servers 230 is hosting is not limiting. However, in some embodiments of the present technology, the resources may comprise digital documents, or simply “documents”, that are representative of web pages.

For example, the plurality of resource servers 230 may host web pages, which means that the plurality of resource servers 230 may store documents representative of web pages and which are accessible by the device 204 and/or by the server 210. A given document may be written in a mark-up language and may comprise inter alia (i) content of a respective web page and (ii) computer-readable instructions for displaying the respective web page (content thereof).

A given one of the plurality of resource servers 230 may be accessed by the device 204 in order to retrieve a given document stored on the given one of the plurality of resource servers 230. For example, aa user may enter a web address associated with a given web page in the given browser application of the device 204 and, in response, the device 204 may access a given resource server hosting the given web page in order to retrieve the document representative of the given web page for rendering the content of the web page. A given one of the plurality of resource servers 230 may be accessed by the server 210 in order to retrieve a given document stored on the given one of the plurality of resource servers 230.

The networked environment 200 comprises a database system 220. The database system 220 is configured to support the operation of the multi-modal input request processing system 250. The database system 220 may be configured to store and manage various types of data required to facilitate processing of input requests comprising text and/or images.

The database system 220 may be configured to store and retrieving information from indexes used by one or more text-based search engines and/or one or more visual search engines. The indexes may comprise inverted indexes structured for efficient querying and retrieval of textual and/or visual data, respectively.

In addition to indexing data, the database system 220 may be further configured to store one or more other data objects that the multi-modal processing workflow may make use of. These data objects may include metadata, feature vectors, classification models, user interaction logs, query templates, other models, or any auxiliary data structures necessary for request interpretation, response generation, and system learning, without departing from the scope of the present technology.

### Multi-Modal Processing System

With reference to FIG. 3, there is depicted a schematic representation of components of the multi-modal input processing system 250, or just “system” 250. As it will be described in greater details herein further below, the system 250 has a multi-modal neural search architecture designed to process multi-modal user inputs comprising natural language (NL) requests and images.

For example, the system 250 is configured to perform processing of multi-modal inputs provided by users of the system 250 via the electronic device 204, for example. The system 250 may configured to acquire a given NL request and a given image, and in response, generate a given NL response for display on the electronic device 204. In one non-limiting implementation of the present technology, the system 250 may be the Yandex™ Neuro™ system operated by Yandex™.

In one embodiment, upon receiving a given multi-modal input, the system 250 initiates a visual search based on the image using a visual search engine. The visual search engine is configured to output visual search results based on recognized objects in the image. These visual search results are in a form of textual information indicative of recognized objects in the image. The recognized objects may have been identified by the visual search engine based on matches from indexed visual content, for example. The output of the visual search, in combination with the original image and the user's NL request, are then processed by a first VLM to generate a modified NL request. This reformulated, or “modified”, request more accurately captures the user's intent by incorporating visual context derived from the image. The system 250 then then performs a text-based search using the modified NL request against a web-scale document index.

In one embodiment, in parallel to the text-based searching, a second VLM is applied to the image to generate a standalone “caption” in a form of textual information indicative of a description of the image. This caption is treated as an additional textual signal for providing context for the final response generation process.

In one embodiment, the system 250 is configured to use inter alia the NL request, the modified NL request, the search results obtained from the text-based search, and the image caption as input into an LLM, which synthesizes a visual-context-aware NL response. The LLM is trained to inject both textual and visual context into the final response, ensuring that the final output is relevant, informative, and aligned with visual and textual contexts of the multi-modal input.

Returning to the description of FIG. 3, the system 250 comprises a plurality of search engines 310. The one or more search engines 310 comprise a text-based search engine 408 and a visual search engine 418. The system 250 comprises the text-based search engine 408 for generating search engine results based on NL requests and the visual search engine 418 for generating visual search engine results based on images. It is contemplated that in some embodiments, both the text-based search and the visual search may be performed by a single search engine comprising text-based searching vertical and an image-based searching vertical, without departing from the scope of the present technology.

Broadly, the text-based search engine 408 is a system that retrieves and ranks documents from a large-scale index in response to NL requests. For example, a modified NL request may be executed against a web-scale search index containing hundreds of billions of documents. The retrieval stage may use an inverted index to identify matching documents and applies neural ranking algorithms (e.g., transformer-based models) to assess relevance of documents based on lexical and semantic features. From the top-ranked candidates, a re-ranking stage may be executed to select the most useful documents for answer generation. This stage may be executed using neural models to predict the informativeness of each document in the context of the modified NL request. In some embodiments, relevant passages can be extracted using a lightweight BERT-based model, and a final set of source snippets can be provided as at least one input into a LLM to synthesize an answer. It is contemplated that the search results used as input into the LLM 422 may comprise one or more relevant passages extracted from one or more relevant web resources.

Broadly, the visual search engine 418 is a system that acquires image input and returns results based on visual similarity or content semantics. For example, visual search may begin with the encoding of the input image using a computer vision model, such as a convolutional neural network (CNN) or Vision Transformer (ViT). The image may be embedded into a semantic feature space, which is then compared against a large index of pre-encoded visual data to identify relevant matches. The pre-encoded visual data may comprise images of products, landmarks, user-generated content, and the like. This retrieval process may be purely visual (based on pixel-level similarity and high-level features) or combined with associated metadata and captions. Visual search results may comprise textual tags, image summary outputs, and OCR outputs.

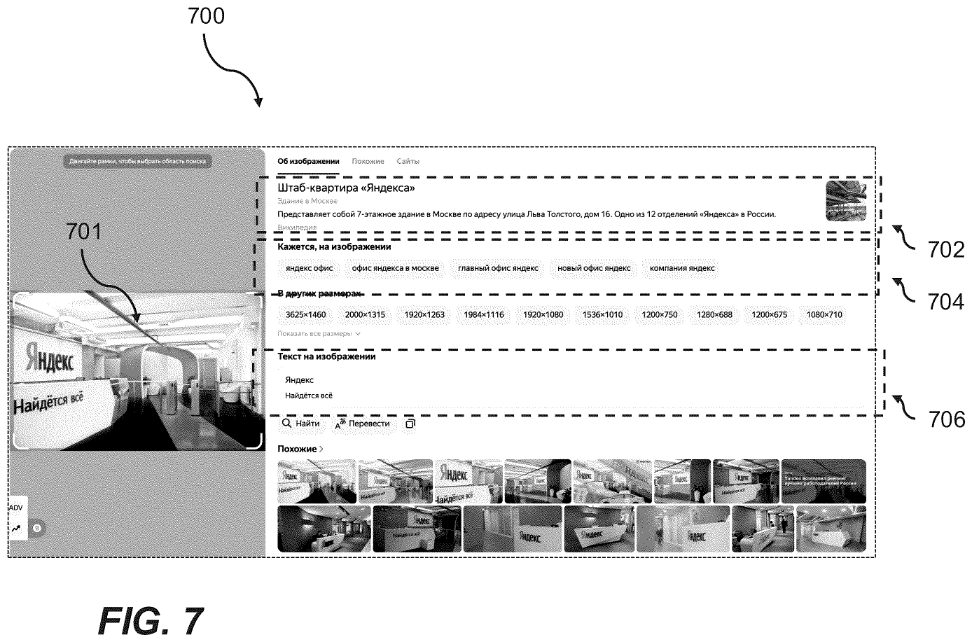

With reference to FIG. 7, there is depicted a screenshot 700 of a Visual Search Engine Results Page (VSERP) generated by the visual search engine 418. The VSERP may be displayed to a user on the electronic device 204, without departing from the scope of the present technology. The VSERP comprises an image object card 702 (e.g., generated using one or more summarization models) for an image 701, a plurality of textual tags 704 (e.g., retrieved from matched images) for the image 701, and OCR output objects 706 for the image 701.

It is contemplated that visual search results generated by a given visual search engine may comprise data indicative of the content of one or more web resources. Such data may include, but is not limited to, textual elements extracted from the associated web pages. For example, if a similar image is detected on a particular website, information may be extracted and further used and which is indicative of the textual content of web page such as a header or title of the web page. Optionally, when a similar image corresponds to an object and/or product shown in an object card, the system may extract and/or further use the name of the object and/or product. In other words, product-related information results may be part of the visual search results generated by the visual search engine, without departing from the scope of the present technology.

Returning to the description of FIG. 3, the system 250 comprises a plurality of VLMs 330. The plurality of VLMs 330 comprises the first VLM 412 configured to generate a modified NL request for inter alia launching a text-based search, and a second VLM 414 configured to generate textual information indicative of a description, or “caption”, of a given image to be used in combination with the modified NL request for generating a response to the multi-modal input.

The first VLM 412 may be referred to as a “rephraser” model configured to generate a modified NL request. In one embodiment, the first VLM 412 is configured to acquire three inputs: (1) the user's original NL request, (2) the input image, and (3) textual information indicative of visual search results. By analyzing the three inputs, the first VLM 412 configured to modify the original NL request so that a modified NL request is a better representation of the image-text pair.

The second VLM 414 may be referred to as a “captioner” model configured to generate textual information indicative of a description or “caption” of the image. The second VLM 414 receives at least one of the original NL request and the modified NL request, as well as the image, and outputs a NL description of the visual content. This NL description is not simply appended to the final response but is treated as an additional context source that a LLM 422, sometimes referred to as a “generator” model, can use for generating the NL response.

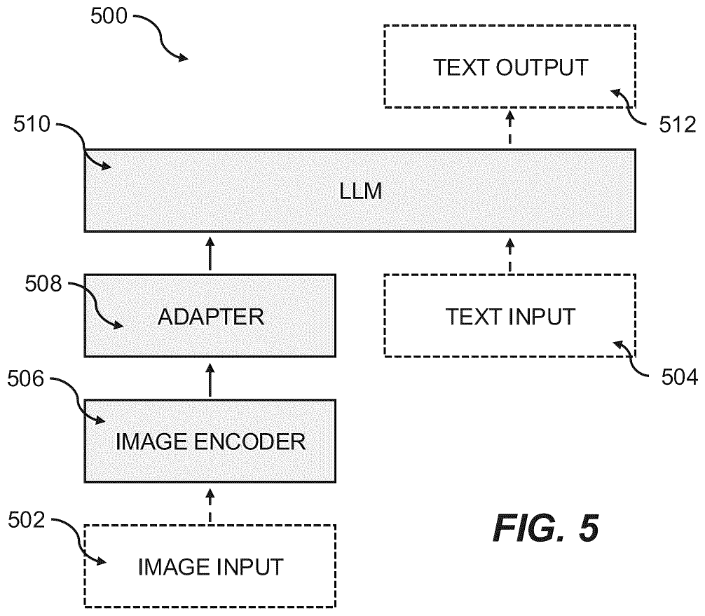

With reference to FIG. 5, there is depicted a VLM architecture 500 configured to process an image input 502 and a text input 504 for generating a text output 512. The VLM architecture 500 comprises an image encoder 506, an adapter 508, and a LLM 510, and which are configured to process multi-modal input comprising both the image input 502 and text input 504 to generate the text output 512. The image encoder 506 is configured to receive the image input 502 and generate a corresponding image representation, such as a feature vector or embedding that captures the visual content of the image input 502. This encoded data is then transmitted to the adapter 508. The adapter 508 acts as an intermediary between the image encoder 506 and the LLM 510. The adapter 508 is configured to transform or align the visual data received from the image encoder 506 into a format that is suited for inter alia the LLM 510 input processing requirements. This may include projecting the visual data into the LLM's embedding space, applying normalization, and/or integrating additional contextual information, without departing from the scope of the present technology. The LLM 510 is configured to receive the text input 504 and the processed visual data provided by the adapter 508. Utilizing its language understanding and generation capabilities, the LLM 310 integrates both the textual and visual modalities to produce a text output 512 that represents a response to the combined input data.

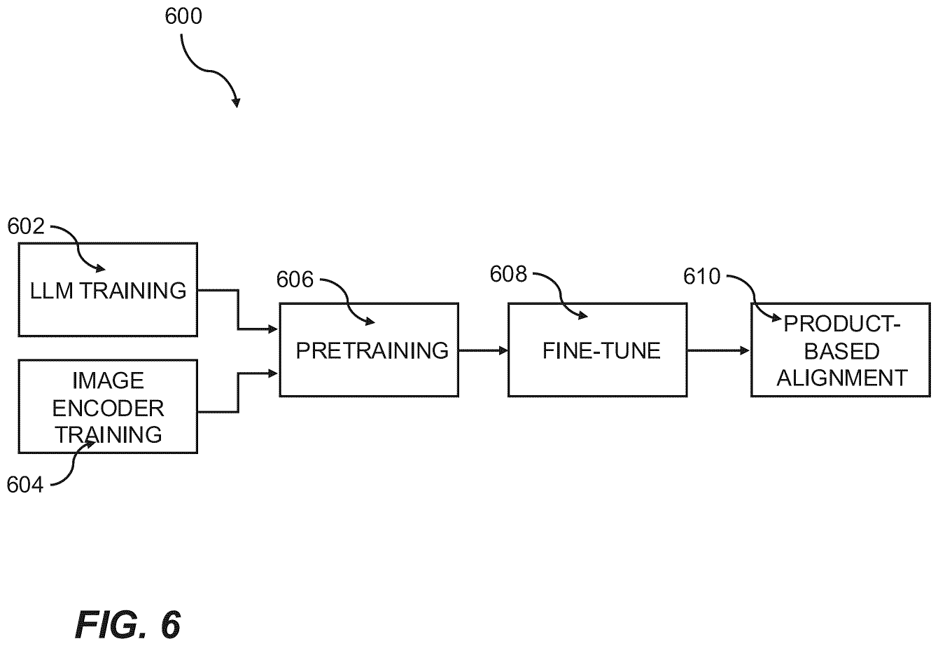

With reference to FIG. 6, there is depicted a training framework 600 of the VLM architecture 500. The training framework 600 is configured to train and optimize the VLM architecture 500, which includes the image encoder 506, the adapter 508, and the LLM 510.

The training framework 600 comprises an LLM training step 602. This step is directed to training the LLM 510 using large-scale textual datasets. The goal of this step is to establish foundational language understanding and generation capabilities. The LLM 510 is trained to recognize linguistic patterns, semantic structures, and contextual reasoning necessary for downstream multi-modal tasks.

The training framework 600 comprises an image encoder training step 604. The image encoder 506 is trained during this step using a dataset of labeled or unlabeled images to learn rich visual representations. This training step may include supervised, self-supervised, or contrastive learning techniques to enable the encoder to extract features that accurately reflect visual content.

The training framework 600 comprises a pre-training step 606. During the pre-training step 606, the VLM architecture 500 is trained as an integrated model using multi-modal data comprising aligned image-text pairs. The pre-training aims to develop cross-modal representations and interaction capabilities between the image encoder 506, the adapter 508, and the LLM 510.

The training framework 600 comprises a fine-tuning step 608. In the fine-tuning step 608, the pre-trained VLM architecture 500 is further refined on a task-specific or domain-specific dataset. This step adapts the model's general multi-modal understanding to a narrower context, improving its performance on specific tasks such as image captioning, visual question answering, and/or product description generation.

The training framework 600 comprises a product-based alignment step 610. The product-based alignment step 610 comprises adjusting the VLM architecture 500 for a particular application or deployment environment. This may include incorporating domain-specific data, optimizing for latency or accuracy trade-offs, and aligning model outputs with product goals and/or regulatory constraints. This step ensures the final VLM system is tuned for practical, real-world usage scenarios.

It is contemplated that the architecture of the first VLM 412 may be implemented similarly to the VLM architecture 500, without departing from the scope of the present technology. It is contemplated that the architecture of the second VLM 414 may be implemented similarly to the VLM architecture 500, without departing from the scope of the present technology. It should be noted that the architecture of the first VLM 412 and of the second VLM 414 may or may not correspond to a same architecture. Irrespective of whether or not the first VLM 412 and the second VLM 414 are implemented using a same architecture, the first VLM 412 is implemented as a separate entity from the second VLM 414, and both VLMs are executed separately by the server 210 without departing from the scope of the present technology.

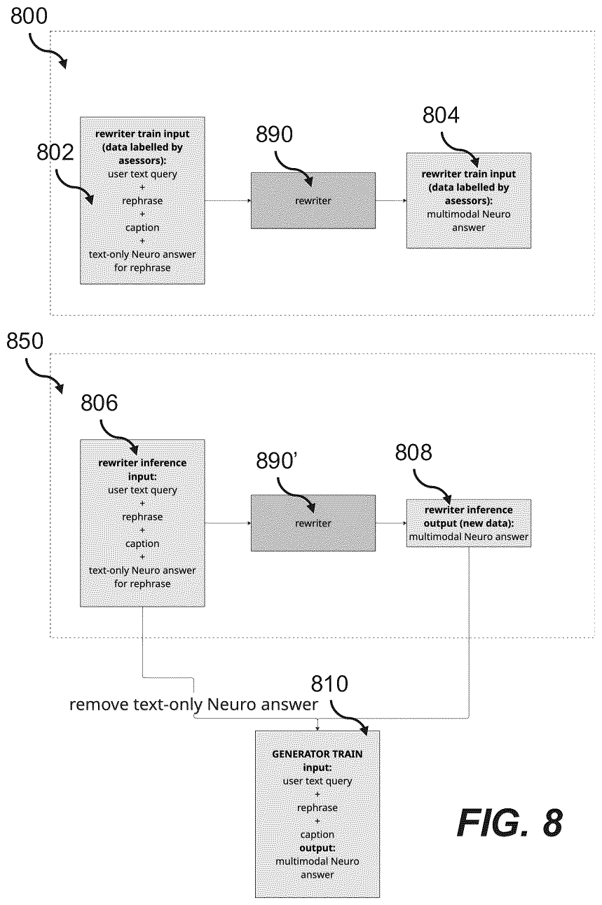

Returning to the description of FIG. 3, the system 250 comprises one or more LLMs 320. The one or more LLMs 320 comprises a LLM 422 configured to generate an NL response based on at least the text-based search results from the text-based search engine, the caption from the second VLM 414, and the modified NL request from the first VLM 412. It is contemplated that the LLM 422 may be trained using a given one from the other models 350 of the system 250. In one non-limiting embodiment, the LLM 422 may be trained using a rewriter model. The rewriter model is configured to generate training datasets for training the LLM 422. How the rewriter model is trained and then used for dataset generation will be described in greater details herein further below with reference to FIG. 8.

### Multi-Modal Processing Pipeline

With reference to FIG. 4, there is depicted a schematic representation of a processing pipeline 400 executable by the system 250. In this embodiment, the system 250 may be configured to acquire a multi-modal input 402 comprising a NL request 404 and an image 406. In this example, let it be assumed that the NL request 404 is “When did it appear?” and the image 406 is an image of a building with a city in the background.

The system 250 is configured to use the visual search engine 408 to perform a visual search. The visual search engine 408 is configured to generate visual search results in a form of first textual information 410 for the image 406. The first textual information 410 may be indicative of recognized objects in the image 406. In this example, let it be assumed that the first textual information 410 comprises inter alia textual tags including “Rome” tag indicative of a recognized city and a “Colosseum” tag indicative of a recognized building. Other textual information may be provided via the visual search results, without departing from the scope of the present technology.

In this embodiment, the first VLM 412 is configured to acquire the NL request 404, the image 406, and the first textual information 410 (visual search results), to generate a modified NL request 416. The modified NL request 416 is a modified version of the NL request 404 and which now, in a sense, comprises the visual context of the image 406. In this example, let it be assumed that the modified NL request 416 is “When did the Colosseum appear?”.

It should be noted that, in contrast to the modified NL request 416, the NL request 404 “When did it appear?” is more ambiguous as it does not provide details about a specific object being referred to in the image 406. It should also be noted that the modified NL request 416 is generated using both the first textual information 410 (visual search results) and the image 406 itself. Assuming that the first textual information 410 comprises the “Rome” tag and “Colosseum” tag, without the visual context extracted from the image 406 itself, a given model may erroneously decide which one of “Rome” and “Colosseum” is the target object referred to in the NL request 404. As a result, employing the first VLM 412 that takes into account the visual context in the image 406 itself, the first VLM 412 may determine that the target object referred to in the NL request 404 is the “Colosseum” and not “Rome”.

In this embodiment, the second VLM 414 is configured to receive as input the image 406 and the NL request 404. It is contemplated that the second VLM 414 may also be configured to acquire the modified NL request, in addition to, or instead of the NL request 404. The second VLM 414 is configured to generate a second textual information 415 indicative of a description of the image 406.

In this embodiment, the system 250 is configured to use the text-based search engine 418 to perform a text-based search. The text-based search engine 418 is configured to generate text-based search results in a form of third textual information 420 for the modified NL request 416. The third textual information 420 may be indicative of one or more text-based search results (e.g., one or more web resources).

In this embodiment, the system is configured to use the LLM 422 for generating a NL response 424. It should be noted that the LLM 422 may be configured to process a variety of input data. In some embodiments, the LLM 422 is configured to acquire at least some of: the NL request 404, the modified NL request 416, the first textual information 410, the second textual information 415, and the third textual information 420. In this non-limiting example, the NL response 422 is “The construction of the Colosseum began in 72 AD under the leadership of Emperor Vespasian. It was completed in 80 AD under the leadership of his son Titus.”.

### Rewriter Model

With reference to FIG. 8, there is depicted a schematic representation of a rewriter 890 executable by the server 210 for training the LLM 422 of the system 250. In FIG. 8, there is depicted a training iteration 800 of the rewriter model 890, and an inference iteration of a trained rewriter model 890′.

In this embodiment, the training iteration 800 is performed using a training set 802. The training set 802 comprises data labelled by a human assessor. The training set 802 comprises a user NL request, a modified NL request, a caption, and “text-only” NL response for the modified NL request. The training target comprises a target 804. The target 804 comprises data labelled by a human assessor. The target 804 comprises a “multi-modal” NL response.

In this embodiment, the inference iteration 850 is performed using an input set 806. The input set 806 comprises a user NL request, a modified NL request, a caption, and text-only NL response for the modified NL request. The trained rewriter model 890′ is configured to generate, based on the input set 806, an output 808 comprising the multi-modal NL response.

In this embodiment, the system 250 is configured to generate a synthetic training set 810 of the LLM 422 by combing at least a portion of the input set 806 and the output 808. The synthetic training set 810 comprises the user NL request, the modified NL request, the caption, and the target being the multi-modal NL request.

In this embodiment, the system 250 may be configured to train the LLM 422 using the synthetic training sets generated by the rewriter model 890′. It should be noted that the rewriter model 890′ may not be used during the processing of a multi-modal input by the system 250.

### Computer-Implemented Method

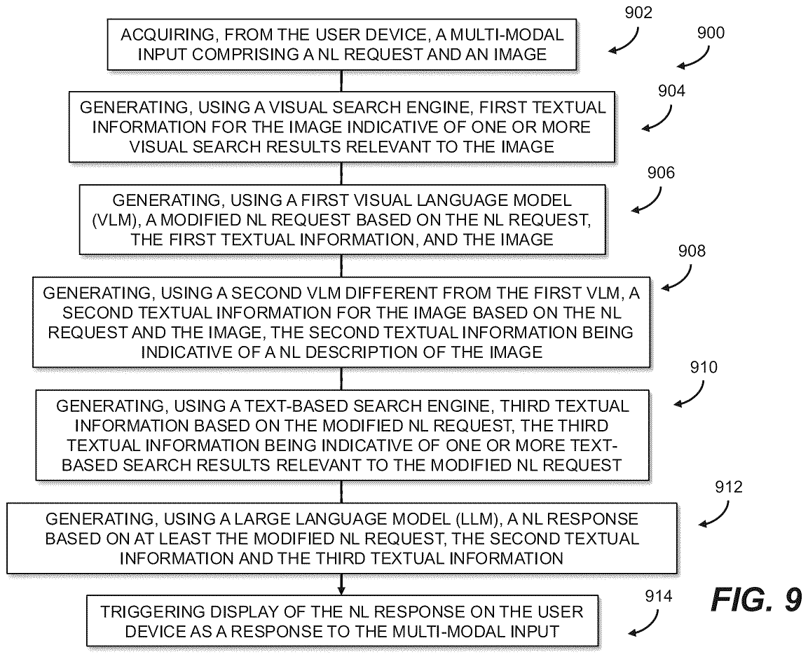

In some embodiments of the present technology, the server 210 is configured to execute a computer-implemented method 900, a scheme-block representation of which is illustrated in FIG. 9. Various steps of the method 900 will now be described.

### Step 902: Acquiring, From the User Device, A Multi-Modal Input Comprising a NL Request and an Image

The method 900 begins at step 902, with the server 210 configured to acquire a multi-modal input comprises a NL request and an image. In one embodiment, the server 210 may be configured to acquire the multi-modal input 402 comprising the NL request 404 and the image 406. The server 210 may be configured to acquire the multi-modal input 402 from the client device 204.

### Step 904: Generating, Using a Visual Search Engine, First Textual Information For the Image Indicative of One or More Visual Search Results Relevant to the Image

The method 900 continues to step 904 with the server 210 configured to generate, using a visual search engine, first textual information for the image indicative of one or more visual search results relevant to the image. In one embodiment, the server 210 may be configured to generate the visual search results 410 based on the image 406. The first textual information may comprise at least one of a textual tag, recognized text in the image 406, web page content from one or more relevant resources, and image object card generated by the visual search engine for the image 406 based on one or more relevant resources.

In some embodiments, the visual search engine 408 may be configured to employ a computer vision model to generate at least a portion of the first textual information 410, such as an Optical Character Recognition (OCR) model, for example.

### Step 906: Generating, Using a First Visual Language Model (VLM), A Modified NL Request Based on the NL Request, the First Textual Information, and the Image

The method 900 continues to step 906 with the server configured to generated, using a first VLM, a modified NL request based on the NL request, the first textual information and the image. In one embodiment, the server 210 may be configured to generate using the first VLM 412 the modified NL request 416 based on the NL request 404, the first textual information 410 and the image 406. The modified NL request is a modified version of the NL request 404.

### Step 908: Generating, Using a Second VLM Different From the First VLM, A Second Textual Information for the Image Based on the NL Request and the Image, the Second Textual Information Being Indicative of a NL Description of the Image

The method 900 continues to step 908 with the server 210 configured to generate, using a second VLM different from the first VLM, a second textual information for the image based on the NL request and the image. The second textual information is indicative of a NL description of the image. In one embodiment, the server 210 may be configured to use the second VLM 414 to generate the NL description 415, or “caption”, for the image 406 and based on the NL request 404 and the image 404.

### Step 910: Generating, Using a Text-Based Search Engine, Third Textual Information Based on the Modified NL Request, the Third Textual Information Being Indicative of One or More Text-Based Search Results Relevant to the Modified NL Request

The method 900 continues to step 910 with the server 210 configured to generate, using a text-based search engine, third textual information based on the modified NL request. The third textual information is indicative of one or more text-based search results relevant to the modified NL request. In one embodiment, the server 210 may be configured to generate, using the text-based search engine 418, the third textual information 420 based on the modified NL request 416. The third textual information 420 is indicative of one or more text-based search results relevant to the modified NL request 416.

In some embodiments, the text-based search engine 418 may be configured to determine one or more web resources that are relevant to the modified NL request 416, and where the one or more web resources are representative the one or more text-based search results. The server 210 may then generate the third textual information 420 based on content from the one or more web resources.

Step 912: Generating, Using a Large Language Model (LLM), A NL Response Based on at Least the Modified NL Request, the Second Textual Information and the Third Textual Information

The method 900 continues to step 910 with the server 210 configured to generate, using an LLM, a NL response based on at least the modified NL request, the second textual information and the third textual information. In one embodiment, the server 210 may be configured to generate, using the LLM 422, the NL response 424 based on at least the modified NL request 416, the second textual information 415 and the third textual information 420. It is contemplated that the NL request 404 may be also used as input to the LLM 422 for generating the NL response 424, without departing from the scope of the present technology. It is contemplated that at least some of the first textual information 410 may be added to inputs of the LLM 422 for generating the NL response 424, without departing from the scope of the present technology. It is contemplated that inputs to the LLM 422 for generating the NL response 424 may comprise at least one of the NL request 404 and the modified NL request 416 (in addition to other inputs), without departing from the scope of the present technology.

In some embodiments, the server 210 may be configured to train the LLM 422. For example, the server 210 may generate, using the rewriter model 890', the output 808 representative of a target multi-modal NL response based on a user NL request, a corresponding modified NL request, a description of a corresponding image, and a text-only NL response (e.g., based on the input 806). The server 210 may generate the synthetic training set 810 comprising the user NL request, the corresponding modified NL request, the description of the corresponding image, and the target multi-modal NL response. The server 210 may be configured to train the LLM 422 using the synthetic training set 810. It is contemplated that the LLM 422 may be a GPT model.

### Step 914: Triggering Display of the NL Response on the User Device as a Response to the Multi-Modal Input

The method 900 continues to step 914 with the server 210 configured to trigger display of the NL response on the user device as a response to the multi-modal input. In one embodiment, the server 210 may be configured to trigger display of the NL response 424 on the user device 204 as a response to the multi-modal input 402. For example, display may be triggered in a browsing application or other app associated with the system 250, without departing from the scope of the present technology.

It should be apparent to those skilled in the art that at least some embodiments of the present technology aim to expand a range of technical solutions for addressing a particular technical problem encountered by the conventional digital content item recommendation systems, namely selecting and providing for display digital content items that are relevant to the users.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

While the above-described implementations have been described and shown with reference to particular steps performed in a particular order, it will be understood that these steps may be combined, sub-divided, or re-ordered without departing from the teachings of the present technology. Accordingly, the order and grouping of the steps is not a limitation of the present technology.

1. A method of generating a Natural Language (NL) response to a multi-modal input, the method executable by a server, the server communicatively coupled to a user device, the method comprising:
acquiring, from the user device, a multi-modal input comprising a NL request and an image;
generating, using a visual search engine, first textual information for the image indicative of one or more visual search results relevant to the image;
generating, using a first Visual Language Model (VLM), a modified NL request based on the NL request, the first textual information, and the image, the modified NL request being a modified version of the NL request;
generating, using a second VLM different from the first VLM, a second textual information for the image based on the NL request and the image, the second textual information being indicative of a NL description of the image;
generating, using a text-based search engine, third textual information based on the modified NL request, the third textual information being indicative of one or more text-based search results relevant to the modified NL request;
generating, using a Large Language Model (LLM), a NL response based on at least the modified NL request, the second textual information and the third textual information; and
triggering display of the NL response on the user device as a response to the multi-modal input.

2. The method of claim 1, wherein the generating the NL response is further based on at least one of the NL request, and the first textual information.

3. The method of claim 1, wherein the first textual information comprises at least one of a textual tag, recognized text in the image, web page content, and image object card.

4. The method of claim 1, wherein the visual search engine is configured to employ a computer vision model to generate at least a portion of the first textual information.

5. The method of claim 1, wherein the visual search engine is configured to employ an Optical Character Recognition (OCR) model to generate at least a portion of the first textual information.

6. The method of claim 1, wherein the generating the third textual information comprises:
determining, by the text-based search engine, one or more web resources that are relevant to the modified NL request, the one or more web resources representative the one or more text-based search results; and
generating the third textual information based on content from the one or more web resources.

7. The method of claim 1, wherein the method further comprises training the LLM, the training comprising:
generating, by a rewriter model, an output representative of a target multi-modal NL response based on a user NL request, a corresponding modified NL request, a description of a corresponding image, and a text-only NL response;
generating a synthetic training set comprising the user NL request, the corresponding modified NL request, the description of the corresponding image, and the target multi-modal NL response; and
training the LLM using the synthetic training set.

8. The method of claim 1, wherein the first VLM comprises an image encoder, an adapter and an other LLM.

9. The method of claim 1, wherein the second VLM comprises an image encoder, an adapter and an other LLM.

10. The method of claim 1, wherein the LLM is a generative pre-trained transformer (GPT) model.

11. A server for generating a Natural Language (NL) response to a multi-modal input, the server communicatively coupled to a user device, the server configured to:
acquire, from the user device, a multi-modal input comprising a NL request and an image;
generate, using a visual search engine, first textual information for the image indicative of one or more visual search results relevant to the image;
generate, using a first Visual Language Model (VLM), a modified NL request based on the NL request, the first textual information, and the image, the modified NL request being a modified version of the NL request;
generate, using a second VLM different from the first VLM, a second textual information for the image based on the NL request and the image, the second textual information being indicative of a NL description of the image;
generate, using a text-based search engine, third textual information based on the modified NL request, the third textual information being indicative of one or more text-based search results relevant to the modified NL request;
generate, using a Large Language Model (LLM), a NL response based on at least the modified NL request, the second textual information and the third textual information; and
trigger display of the NL response on the user device as a response to the multi-modal input.

12. The server of claim 11, wherein to generate the NL response is further based on at least one of the NL request, and the first textual information.

13. The server of claim 11, wherein the first textual information comprises at least one of a textual tag, recognized text in the image, web page content, and image object card.

14. The server of claim 11, wherein the visual search engine is configured to employ a computer vision model to generate at least a portion of the first textual information.

15. The server of claim 11, wherein the visual search engine is configured to employ an Optical Character Recognition (OCR) model to generate at least a portion of the first textual information.

16. The server of claim 11, wherein to generate the third textual information comprises the server configured to:
determine, by the text-based search engine, one or more web resources that are relevant to the modified NL request, the one or more web resources representative the one or more text-based search results; and
generate the third textual information based on content from the one or more web resources.

17. The server of claim 11, wherein the server is further configured to train the LLM, to train comprises the server configured to:
generate, by a rewriter model, an output representative of a target multi-modal NL response based on a user NL request, a corresponding modified NL request, a description of a corresponding image, and a text-only NL response;
generate a synthetic training set comprising the user NL request, the corresponding modified NL request, the description of the corresponding image, and the target multi-modal NL response; and
train the LLM using the synthetic training set.

18. The server of claim 11, wherein the first VLM comprises an image encoder, an adapter and an other LLM.

19. The server of claim 11, wherein the second VLM comprises an image encoder, an adapter and an other LLM.

20. The server of claim 11, wherein the LLM is a generative pre-trained transformer (GPT) model.
